(19) United States
(12) Patent Application Publication
(10) Pub. No.: US 2009/0267764 A1
(43) Pub. Date: Oct. 29, 2009

(54) "Catch One" system

(76) Inventors: Richard L. Klaas, Carrollton, VA (US); Douglas R. Gordon, Suffolk, VA (US)

Correspondence Address: RICHARD L. KLAAS, 15110 ASHBY WAY W, CARROLLTON, VA, 23314, US

(21) Appl. No.: 12/069,026

(22) Filed: Apr. 24, 2008

(51) Int. Cl. G08B 13/00

(52) U.S. Cl. 340/541

(57) ABSTRACT

The system will consist of components/materials that are readily available in the marketplace and will not require any development and subsequent approval of new technologies or materials. The system components (deadbolt mechanisms, pushbutton stations, and central connection/control panel) will be hardwired to ensure that the system's operation will not be hindered or disabled by any external signal source that could unintentionally or deliberately interfere with the operating frequency of a wireless control system. The system will be powered via a 120VAC, 60 Hz circuit provided by a dedicated circuit within a power panel located in the bank's electrical/mechanical room. Details of system operation are provided in the attached System Narrative and sketches labeled FIG. 1 and FIG. 2.

### PURPOSE

This system is designed to detain perpetrators of a bank robbery attempt until law enforcement personnel can arrive on the scene.

### OVERVIEW

The system will consist of a vestibule constructed of bulletproof materials located at the bank entrance. The vestibule will contain an outer set of doors leading into the vestibule from outside and an inner set of doors leading from the vestibule to the bank lobby. Both sets of doors will be constructed of bulletproof glass and will include a center post.

The inner and outer set of doors will each be equipped with an electrically actuated deadbolt mechanism. Each individual door will include a deadbolt to be mounted in the center post between the doors. Each deadbolt will incorporate a “sliding bolt” action for locking and unlocking a door. In the actuated (locked) position, each bolt will extend into the edge of its respective door. In the unlocked position, each bolt will retract into the center post. These deadbolts will be remotely operated from pushbuttons located behind the teller stations in the lobby. Each teller station will include a simple pushbutton station consisting of an “inner door” and an “outer door” pushbutton. Each pushbutton station will be hidden from view from the lobby yet will be easily accessible to the teller.

In the event of a robbery attempt, this simple system would be utilized as follows:
One of the tellers would press the “outer” pushbutton to lock down the outer vestibule doors as the perpetrators prepare to leave.
As the perpetrators pass through the vestibule area on their way outside, one of the tellers would press the “inner” pushbutton to lock down the inner vestibule doors to detain the suspects inside the vestibule.
When law enforcement personnel arrive, the deadbolts would be unlocked (“outer” doors first) using a centrally located pushbutton.

### DETAILED DESCRIPTION

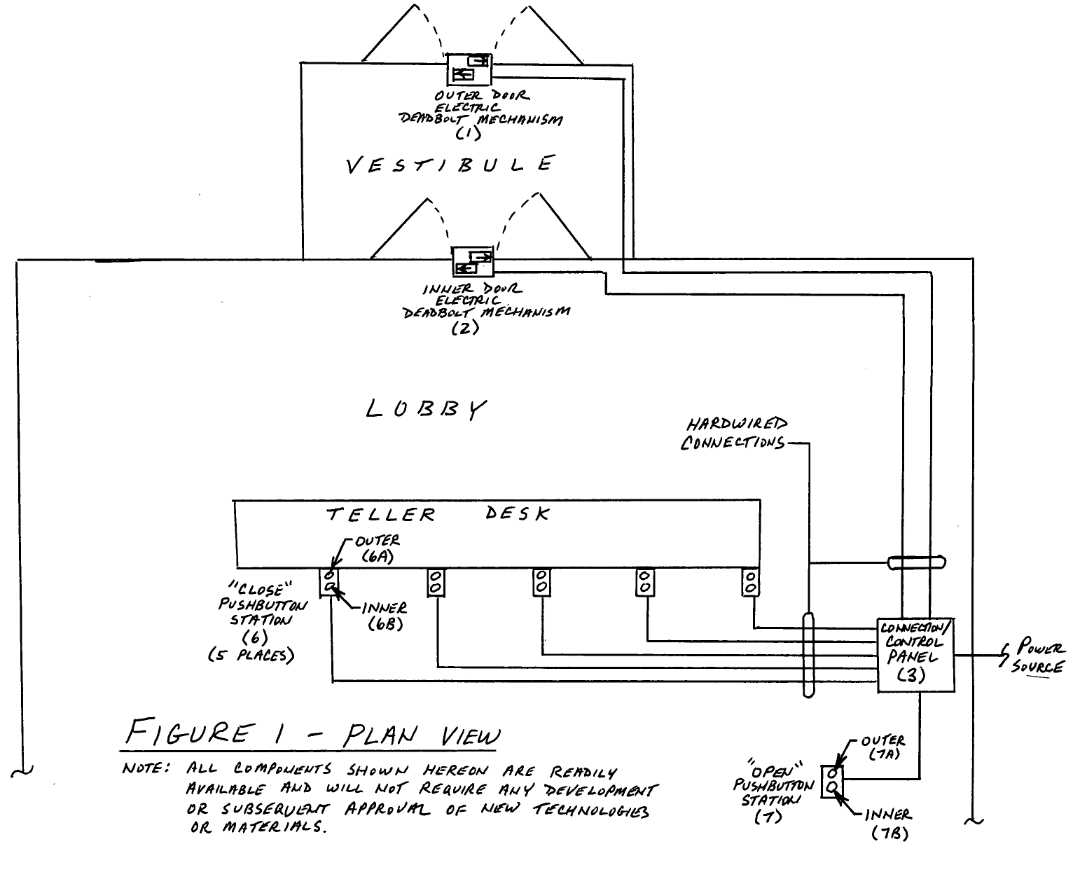

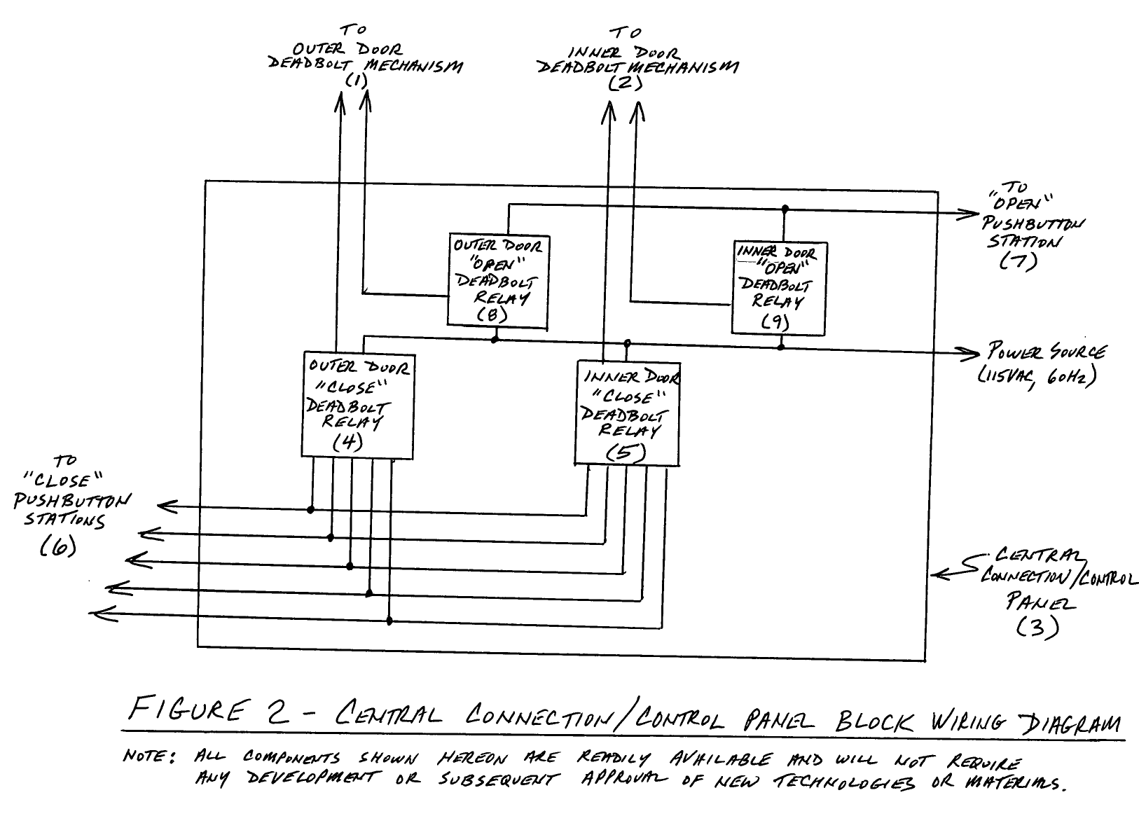

Details of system operation are provided in attached FIGS. 1 and 2. FIG. 1 provides a notional arrangement of pushbutton stations, deadbolt mechanisms, and central connection/control panel associated with a typical bank lobby arrangement. FIG. 2 provides a block wiring diagram of the deadbolt relays located within the central connection/control panel. Components shown on these figures are numerically labeled (1), (2), (3), etc., and are referred to accordingly in the detailed description below.

All components comprising this system will be designed to operate using 115VAC, 60 Hz supply voltage. This system will not incorporate wireless (infrared) control and will not interconnect or interfere with bank security and alarm systems already in place.

Outer vestibule doors will incorporate an electrically actuated deadbolt mechanism (1). Inner vestibule doors will also incorporate an electrically actuated deadbolt mechanism (2). Inner and outer deadbolt mechanism (1) and (2) will each be hardwired into a central connection panel (3). The central connection panel will house four multi-contact relays. Two of the relays will be utilized to close the inner and outer deadbolt mechanism (1) and (2). The other two relays will be utilized to open the inner and outer deadbolt mechanism (1) and (2). The central connection panel (3) will utilize a 115VAC, 60 Hz power source to provide control and actuation power for all peripheral hardwired components.

Each teller station will be outfitted with a small pushbutton enclosure (6) consisting of two pushbuttons. Each “close outer” pushbutton (6A) will be hardwired to the outer close control relay (4) housed in the central connection panel (3). Each “close inner” pushbutton (6B) will be hardwired to the inner close control relay (5) housed in the central connection panel (3). Outer close control relay (4) will be hardwired to the outer deadbolt mechanism (1) and Inner close control relay (5) will be hardwired to the inner deadbolt mechanism (2).

A single pushbutton enclosure (7) consisting of two pushbuttons will be located in a discrete location. The “open outer” pushbutton (7A) will be hardwired to the outer open control relay (8) housed in the central connection panel (3). The “open inner” pushbutton (7B) will be hardwired to the inner open control relay (9) housed in the central connection panel (3). Outer open control relay (8) will be hardwired to the outer deadbolt mechanism (1) and Inner open control relay (9) will be hardwired to the inner deadbolt mechanism (2).

### Sequence of Operation

In the event of a robbery, one of the tellers will push their “close outer” button (6A) to close the outer vestibule doors (several tellers simultaneously pushing their respective “close outer” buttons will not affect the operation of the system).
Upon receiving a closed control loop due to a depressed pushbutton (6A), the outer close control relay (4) will actuate and close its contacts to complete the deadbolt actuation circuit. The outer deadbolt mechanism (1) will receive 115VAC to close, and the outer vestibule doors will be locked down.
Moments afterward, when the perpetrators have passed into the vestibule to leave the bank, one of the tellers will push their “close inner” button (6B) to close the inner vestibule doors (several tellers simultaneously pushing their respective “close inner” buttons will not affect the operation of the system). The sequence for closing the inner doors does not have to be initiated by the same teller who initiated the sequence for closing the outer doors.
Upon receiving a closed control loop due to a depressed pushbutton (6B), the inner close control relay (5) will actuate and close its contacts to complete the deadbolt actuation circuit. The inner deadbolt mechanism (2) will receive 115VAC to close, and the inner vestibule doors will be locked down.
The inner and outer vestibule doors will remain closed as long as necessary for law enforcement personnel to arrive on the scene. The inner and outer doors can then be unlocked by accessing the single pushbutton station (7).
Upon receiving a closed control loop due to a depressed pushbutton (7A), the outer open control relay (8) will actuate and close its contacts to complete the deadbolt actuation circuit. The outer deadbolt mechanism (1) will receive 115VAC to open, and the outer vestibule doors will no longer be locked down.
Likewise, upon receiving a closed control loop due to a depressed pushbutton (7B), the inner open control relay (9) will actuate and close its contacts to complete the deadbolt actuation circuit. The inner deadbolt mechanism (2) will receive 115VAC to open, and the inner vestibule doors will no longer be locked down.

1. The “system” is designed to detain the perpetrator of the crime of theft. As the perpetrator attempts to exit the building, the outer door of the vestibule shall be locked electronically by the Clerk.
When the perpetrator reaches the outer door of the vestibule, the inner door shall be electronically locked by the clerk. At that time the Perpetrator is contained in the vestibule until law enforcement arrives. The “system” is specifically designed for branch banks, convenience stores, and any other retail business where theft is a threat.
We hereby claim that the system will perform the task as described herein, and further described in the system narrative attached.
